(19) United States
(12) Patent Application Publication
(10) Pub. No.: US 2013/0311195 A1
(43) Pub. Date: Nov. 21, 2013

(54) NURSING SUPPORT SYSTEM AND METHOD

(71) Applicant: TOSHIBA TEC KABUSHIKI KAISHA, Tokyo (JP)

(72) Inventors: Katsuyuki Suzuki, Shizuoka-ken (JP); Shunichiro Kamamoto, Shizuoka-ken (JP); Natsuko Iwamoto, Kanagawa-ken (JP)

(73) Assignee: TOSHIBA TEC KABUSHIKI KAISHA, Tokyo (JP)

(21) Appl. No.: 13/892,744

(22) Filed: May 13, 2013

(30) Foreign Application Priority Data
May 18, 2012 (JP) 2012-114806

(51) Int. Cl. G06F 19/00

(52) U.S. Cl. CPC G06F 19/3418
USPC 705/2

(57) ABSTRACT

According to one embodiment, a nursing support system includes a handy terminal and an information processing apparatus capable of communicating with the handy terminal. The information processing apparatus includes a selection unit selects a responsible person to use the handy terminal, an item setting unit sets input items of the handy terminal corresponding to the patient and the department of the selected responsible person, a printing unit prints a key sheet installed on the input unit of the handy terminal based on the set input items and an item notifying unit notifies the handy terminal of the set input items. The handy terminal includes a key layout unit lays out keys of the input unit based on the input items notified by the information processing apparatus.

### CROSS-REFERENCE TO RELATED APPLICATION

This application is based upon and claims the benefit of priority from Japanese Patent Application No. 2012-114806, filed May 18, 2012, the entire contents of which are incorporated herein by reference.

### FIELD

Embodiments described herein relate to a nursing support system and method.

### BACKGROUND

Conventionally, in order to make medical/nursing services proceeded efficiently, a nursing support system is introduced into a hospital to support the medical/nursing services which includes viewing patient-related data and input data and the like, with the nurses and doctors and the like of responsible persons utilizing a handy terminal such as the PDA (Person Digital Assistant) and the like.

### BRIEF DESCRIPTION OF THE DRAWINGS

FIG. 1 is a schematic diagram illustrating the whole structure of a nursing support system according to one embodiment.

FIG. 2 is a diagram illustrating the data structure of a nurse DB.

FIG. 3 is a diagram illustrating the data structure of a patient DB.

FIG. 4 is a diagram illustrating the data structure of a nursing job DB.

FIG. 5 is a block diagram illustrating hardware configurations of a terminal apparatus.

FIG. 6 is a front view roughly illustrating the schematic structure of a handy terminal.

FIG. 7 is a block diagram illustrating hardware configurations of a handy terminal.

FIG. 8 is a sequence diagram illustrating an example of the actions of a nursing support system.

FIG. 9 is a diagram illustrating a printed key sheet.

### DETAILED DESCRIPTION

In accordance with one embodiment, a nursing support system, including a handy terminal and an information processing apparatus capable of communicating with the handy terminal, wherein the information processing apparatus includes a selection unit configured to select a responsible person to use the handy terminal, an item setting unit configured to set input items of the handy terminal corresponding to the patient and the department of the selected responsible person by referring the information of the responsible person recording the patient and the department of the responsible person for every responsible persons, a printing unit configured to print a key sheet installed on the input unit of the handy terminal based on the set input items and an item notifying unit configured to notify the handy terminal of the set input items, wherein the handy terminal includes a key layout unit configured to lay out keys of the input unit based on the input items notified by the information processing apparatus.

In addition, in accordance with one embodiment, a nursing support method comprising: selecting a responsible person to use a handy terminal; setting input items of the handy terminal corresponding to the patient and the department of the selected responsible person by referring the information of the responsible person recording the patient and the department of the responsible person for every responsible persons; printing a key sheet installed on the input unit of the handy terminal based on the set input items; and notifying the handy terminal of the set input items via a communication unit.

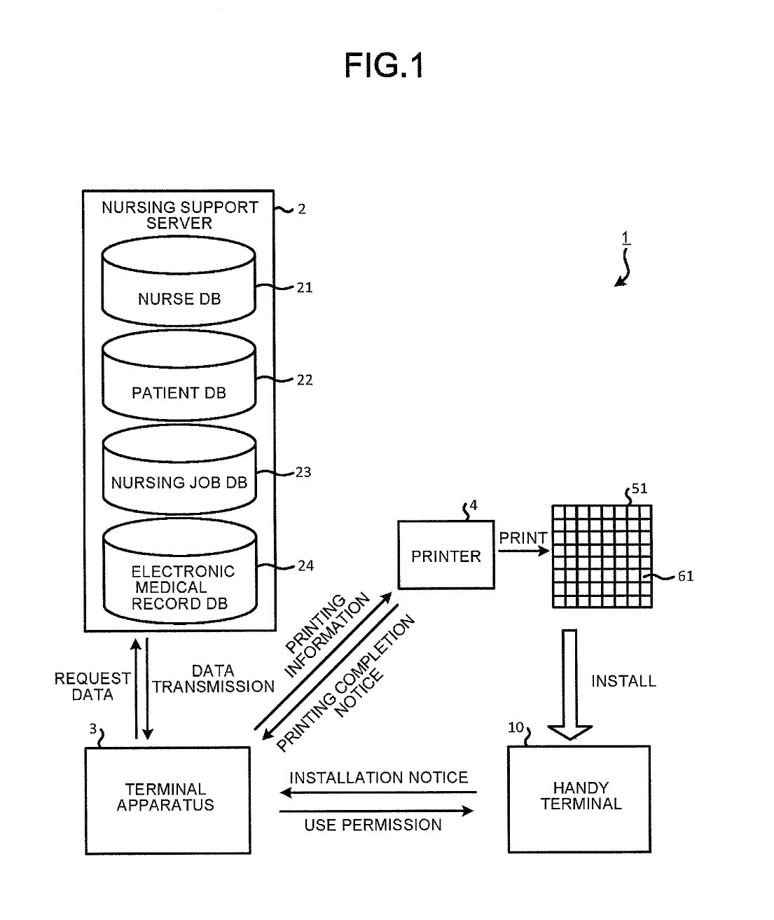

FIG. 1 is a schematic diagram illustrating the whole structure of a nursing support system 1 according to one embodiment.

As shown in FIG. 1, the nursing support system 1 includes mainly a nursing support server 2, a terminal apparatus 3 serving as an information processing apparatus, a printer 4 and a handy terminal 10 carried and used by a responsible person such as a nurse or doctor. Additionally, in one embodiment, the responsible person using the handy terminal 10 is assumed a nurse.

In the nursing support system 1, the nursing support server 2, the terminal apparatus 3 and the printer 4 can communicate with each other via a communication network, such as a wired or wireless LAN (Local Area Network), installed in a hospital. Further, the handy terminal 10 may be connected with the nursing support server 2 and the terminal apparatus 3 through the wireless communication of the wireless LAN. In addition, although each member is singly shown in FIG. 1, the number of each apparatus may be more than one.

The nursing support server 2 mainly includes a control apparatus such as a CPU (Central Processing Unit), a memory apparatus such as an ROM or RAM, an external memory apparatus such as an HDD or CD drive, a display apparatus such as a display, an input apparatus such as a keyboard or mouse and a communication I/F (Interface) and the like, which has the hardware configurations of a general computer.

The nursing support server 2 comprises: a nurse DB (Database) 21 in which the patient to be attended by a nurse as well as which the nurse is responsible to aiming at each nurse are recorded; a patient DB 22 in which the department visited by a patient and the ward number of the ward where the patient is in aiming at each patient are recorded; a nursing job DB 23 in which the jobs a nurse conducts and the relation between the jobs conducted by the nurse and the departments related to the jobs are recorded; and an electronic medical record DB in which the medical record of each patient is electronically recorded. The nursing support server 2 sends, according to the data request of the terminal apparatus 3 or the handy terminal 10, the data recorded in the nurse DB 21, the patient DB 22, the nursing job DB 23 and the electronic medical record DB 24 to the request source. In addition, the nursing support server 2 updates, according to the data update request of the terminal device 3 or the handy terminal 10, the data recorded in the nurse DB 21, the patient DB 22, the nursing job DB 23 and the electronic medical record DB 24.

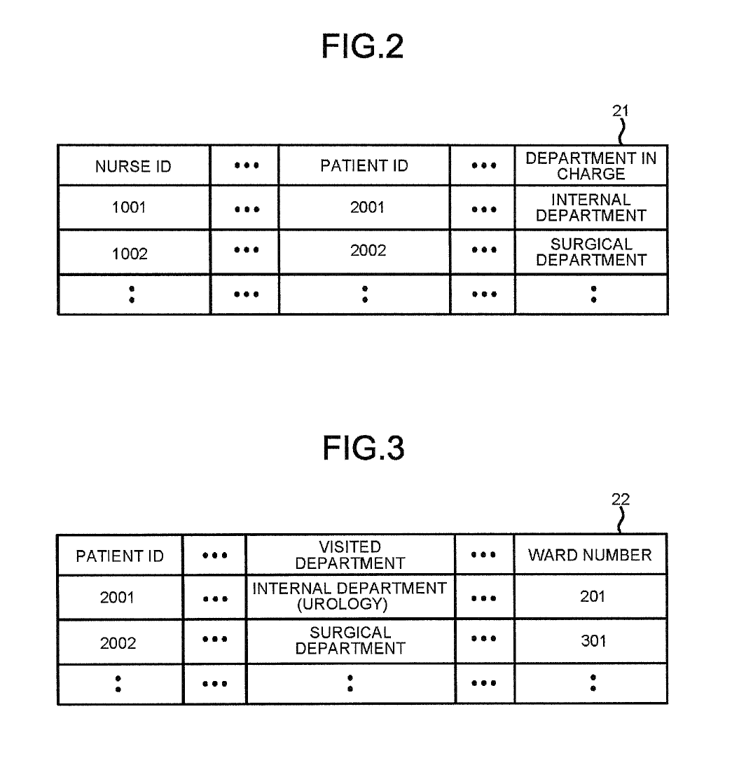

FIG. 2 is a diagram illustrating the data structure of the nurse DB 21. As shown in FIG. 2, the nurse DB 21 is the nurse's information recording the patient ID of the patient and the name of the department a nurse is responsible to in association with a nurse ID identifying the nurse. For example, for a nurse whose nurse ID is ‘1001’, a patient ID ‘2001’ representing the patient to be attended by the nurse and a department name ‘Internal Medicine’ representing the department the patient is responsible to are recorded in association with the nurse ID ‘1001’. Therefore, by reference to the nurse DB 21 based on a nurse ID, the patient and the department the nurse identified by the nurse ID responsible to can be read.

FIG. 3 is a diagram illustrating the data structure of the patient DB 22. As shown in FIG. 3, in the patient DB 22, the department a patient visits and the ward number of the ward the patient is in are recorded in association with the patient ID identifying of the patient. For example, for a patient whose patient ID is ‘2001’, a visited department ‘Internal Medicine (urinary organ)’ and a ward number “201” are recoded in association with the patient ID ‘2001’. Therefore, by referring to the patient DB 22 based on a patient ID, the department the patient identified by the patient ID visits and the ward number of the ward where the patient is in can be read.

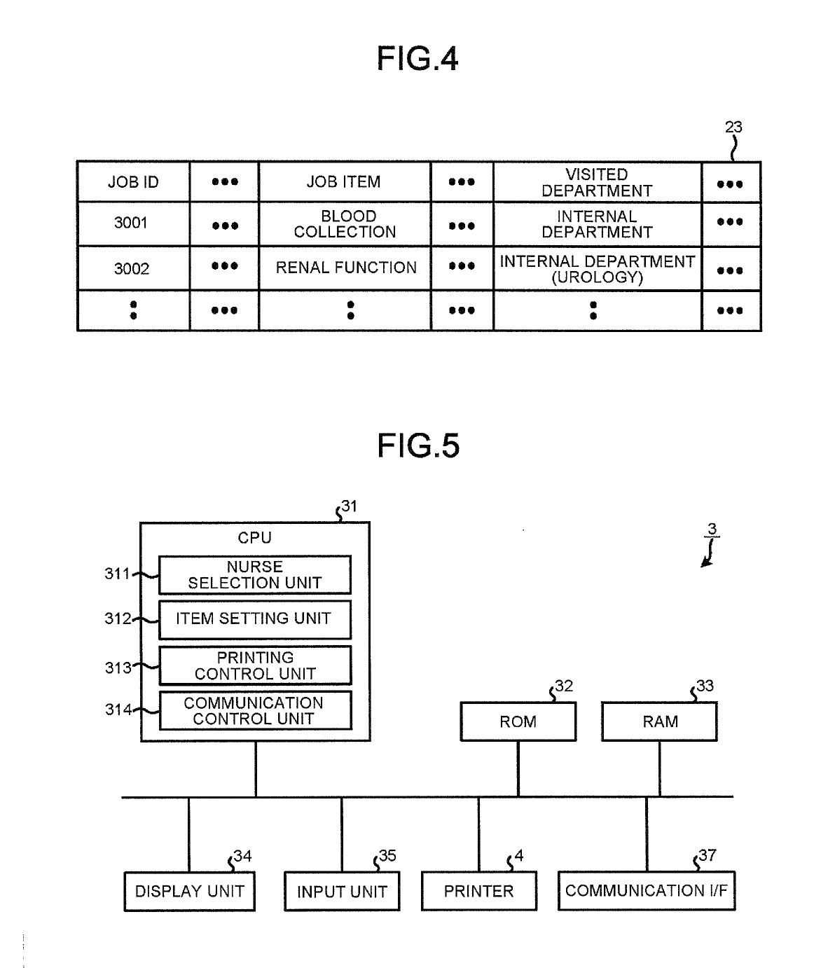

FIG. 4 is a diagram illustrating the data structure of the nursing job DB 23. As shown in FIG. 4, in the nursing job DB 23, for a job ID identifying the job conducted by a nurse, a job item representing the item of a job and the department from where the job item is distributed are recorded in association with the job ID. For example, for the job identified by a job ID ‘3001’, a job item ‘collect blood’ and a department ‘Internal medicine’ are recorded. Therefore, by referring to the nursing job DB 23 based on a job ID, a job item of a job identified by the job ID and the department to where the job is distributed can be read.

Return to FIG. 1, the terminal apparatus 3 is an apparatus which executing various job application programs and an information processing apparatus such as a PC (Personal Computer) which carries out various jobs requesting data from the nurse DB 21, the patient DB 22, the nursing job 23 and the electronic medical record DB 24 comprised of the nursing support server 2 and using the data sent from the nursing support server 2.

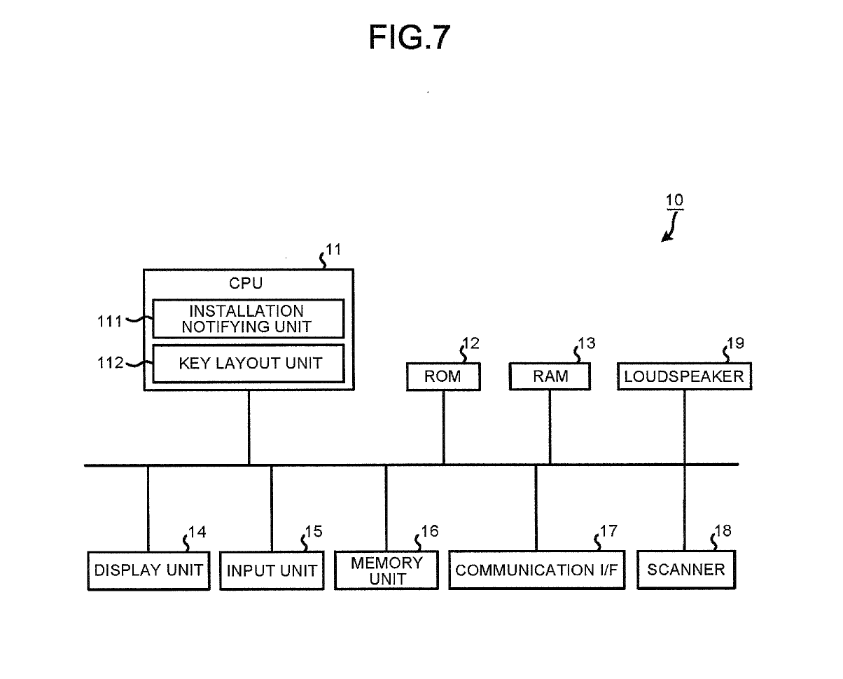

Specifically, one of the jobs executed by the terminal apparatus 3 by executing an application program is as follows: set input items 61 of a key sheet 51 installed on the input unit 15 (refer to FIG. 7) of the handy terminal 10, then notify the print information of the key sheet 51 which set the input item 61 on the printer 4 and some necessary setting information such as the configuration position and the like of the key layout of the input item 61 set on the key sheet 51 to the handy terminal 10. Further, the terminal apparatus 3 accepts a mounting notice from the handy terminal 10 to denote the mounting of the input unit 15 onto the key sheet 51 and notifies the handy terminal 10 a use permission for the use of the input items 61 set on the key sheet 51. In the handy terminal 10, the operation of the input unit 15 conducted according to the set information of the input items 61 set on the key sheet 51 starts based on the use permission notified by the terminal apparatus 3, that is, the operation, which conducted according to the input items 61 of the key sheet 51 which is mounted on the input unit 51 after being printed by the printer 4 starts.

FIG. 5 is a block diagram illustrating hardware configurations of the terminal apparatus 3. As shown in FIG. 5, the terminal apparatus 3 mainly includes a control apparatus such as a CPU 31, a memory apparatus such as an ROM 32 or RAM 33, a display apparatus such as a display unit 34, an input unit 35 such as a touch panel or keyboard, a printer 4 such as a thermal printer and a communication I/F 37, which has the same hardware configurations like a general personal computer.

The CPU 31 of the terminal apparatus 3 functions as a nurse selection unit 311, an item setting unit 312, a printing control unit 313 and a communication control unit 314 by developing and executing the application programs stored in the memory apparatus (not shown) such as the ROM 32 or HDD in the RAM 33.

The nurse selection unit 311 accepts the operation conducted by the user using the input unit 35 to select a responsible person, that is, a nurse to use the handy terminal 10. Specifically, the nurse selection unit 311 displays a list of nurses based on the data read from the nurse DB 21, a selection screen selected by a nurse contained in the list of nurses displayed on the display unit 34 and accepts a selection on a nurse corresponding to an operation instruction of the input unit 35.

The item setting unit 312 sets the input items of the handy terminal 10 corresponding to the patient and the department the nurse selected by the nurse selection unit 311 is responsible to. Specifically, the item setting unit 312 extracts, for the nurse selected by the nurse selection unit 311, a patient (patient ID) and a department to which the nurse is responsible and which are recorded corresponding to a nurse ID identifying the patient are selected by referring to the nurse DB 21 using the nurse ID. In addition, the item setting unit 312 extracts a visited department and a ward number recorded corresponding to the patient ID of the selected patient by referring to the patient DB 22 using the patient ID of the selected patient. Next, the item setting unit 312 extracts a job item corresponding to the selected department the nurse is responsible to and the selected visited department by referring to the nursing job DB 23 using the selected department the nurse is responsible to and the selected visited department. The item setting unit 312 determines, based on the data selected from the nurse DB 21, the patient DB 22 and the nursing job DB 23 according to the nurse ID of the selected nurse, the input items of the handy terminal 10 and creates setting information of assigning the determined input items on keys of the input unit 15 of the handy terminal 10.

For example, an input item designating the input of a ward number by selecting the selected ward number is assigned to a key in an area for inputting a ward number on the input unit 15 of the handy terminal 10. Further, an input item indicative of the processing of a job item by selecting the selected job item is assigned to a key in an area for selecting a job item on the input unit 15 of the handy terminal 10. Further, in addition to the selected ward number and the selected job item, an input item indicative of a preset basic job or system operation is assigned to a given key on the input unit 15 of the handy terminal 10. Then, the item setting unit 312 creates setting information describing the configuration position of a key subjected to the input item setting and the correspondence between the input items and those configurations.

The printing control unit 313 prints the key sheet 51 installed on the input unit 15 by using the printer 4 based on the input item on the input unit 15 of the handy terminal 10 set by the item setting unit 312. Specifically, the printing control unit 313 generates, based on the set information created by the item setting unit 312, printing information indicating the printer 4 to print the key sheet 51 in such a type that the name of an input item is printed at the configuration position of a given key on the input unit 15, and outputs the printing information to the printer 4. The printer 4 prints the key sheet 51 based on the printing information output by the printing control unit 313. Further, the printer 4 outputs, after printing the key sheet 51, a printing completion notice indicative of the completion of the printing to the terminal apparatus 3.

The communication control unit 314 controls the data communication on the terminal apparatus 3 and the nursing support server 2, the printer 4 and the handy terminal 10 carried out through the communication I/F 37. Specifically, the communication control unit 314 controls a data request from the nursing support server 2 and the sending of the requested data from the nursing support server 2. In addition, the communication control unit 314 controls the sending of printing information to the printer 4 and the receiving of a printing completion notice after the key sheet 51 is printed. Further, the communication control unit 314 controls the notifying of the input items of the handy terminal 10 set by the item setting unit 312 to the handy terminal 10, more specifically, the communication control unit 314 controls the notifying of the setting information created by the item setting unit 312 to the handy terminal 10, the notifying of a use permission for the use of the input items on the handy terminal 10, and the receiving of an installation notice from the handy terminal 10.

Further, the setting information can also be notified to the handy terminal 10 when the setting information is created by the item setting unit 312 or a printing completion notice is received by the printer 4, while an installation notice is notified to the handy terminal 10 along with a use permission for the installation notice when it is received from the handy terminal 10. In this way, a use permission for a printed key sheet 51 installed in the handy terminal 10 and setting information are notified to the handy terminal 10.

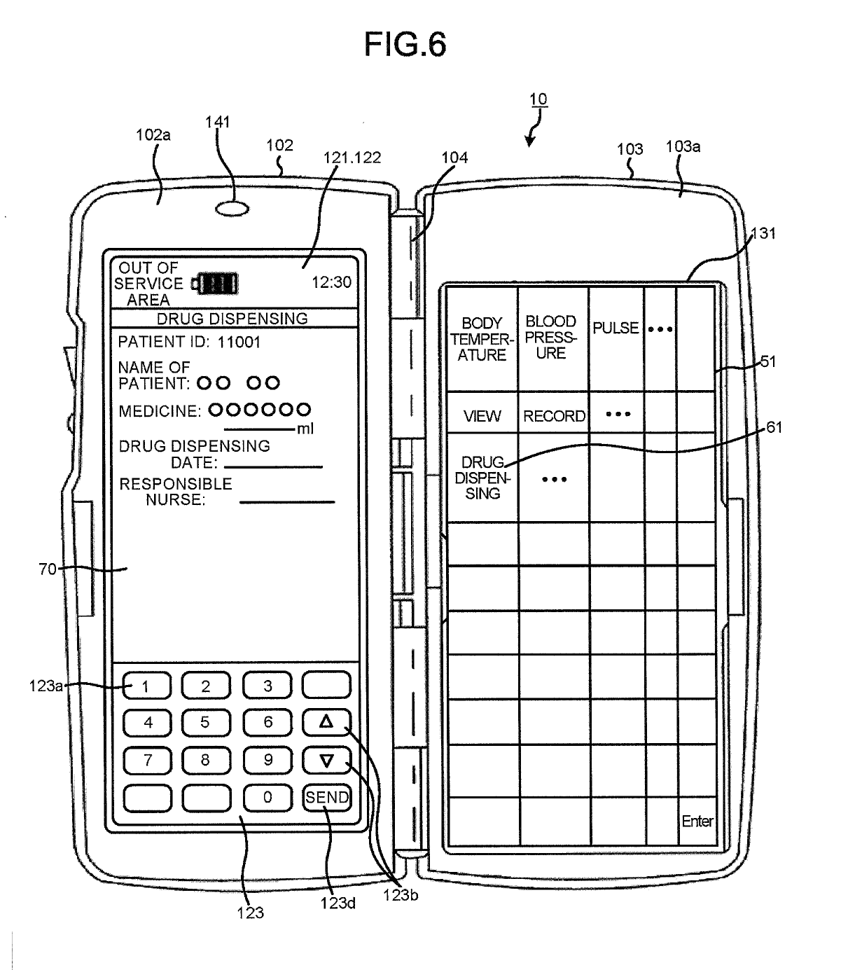

Return to FIG. 1, the handy terminal 10 is a portable information communication terminal carried and used by a responsible person such as a nurse. FIG. 6 is a front view illustrating the schematic structure of the handy terminal 10. As shown in FIG. 6, the handy terminal 10 comprises a left unit 102 and a right unit 103, which can be rotationally opened or closed through a hinge 104 to be connected with each other.

A display 121 such as a liquid crystal display is arranged on the housing 102a of the left unit 102. A touch panel 122 is laminated on the surface of the display 121. A key sheet 123 is designed on the touch panel 122 on the lower portion (the middle-lower part shown in FIG. 6) of the touch panel 122. The key sheet 123 includes a keypad 123a for displaying numerals, arrow keys 123b for displaying an arrow ‘Up’ and an arrow ‘down’ and a sending key 123d for displaying ‘send’. Different from the key sheet 51 described above, the key sheet 123 is fixedly arranged on the handy terminal 10. A microphone 141 for accepting a voice input is arranged on the upper portion (the upper side in FIG. 6) of the display 121.

A keyboard 131 on which a plurality of keys are arranged is arranged on the housing 103a of the right unit 103. The keyboard 131 is used by being installed with a printed key sheet 51. A plurality of input items 61 presented by item words such as ‘body temperature’, ‘blood pressure’, ‘pulse’, ‘view’ and ‘record’ are arranged as keys of the keyboard 131.

FIG. 7 is a block diagram illustrating hardware configurations of the handy terminal 10. As shown in FIG. 7, the handy terminal 10, as a micro computer, comprises a CPU 11, an ROM 12 and an RAM 13 to execute information processing. Further, the CPU 11 is connected with a display unit 14, an input unit 15, a memory unit 16, a communication I/F 17 and a loudspeaker 19 via various interfaces or a bus line.

Further, the CPU 11 is connected with a scanner 18 for reading the data recorded as a code symbol such as a barcode or two-dimensional code via a interface. Further, the CPU 11 may be connected with an RFID, instead of the scanner 18, to read the data recorded in an IC tag.

The CPU 11 controls the handy terminal 10 comprehensively by executing the various programs stored in the ROM 32 or the memory unit 16. The ROM 12 stores the programs for executing basic actions. The RAM 13, which is the main memory apparatus of the handy terminal 10, functions as the work area of the CPU 11.

The display unit 14 is a display apparatus 121 or an LED (Light Emitting Diode) (not shown). The CPU 11 controls the displaying of the display 121 and lighting or extinguishes of the LED. The input unit 15 is an input apparatus such as a touch panel 122, a keyboard 131 and a microphone 141.

The memory unit 16 is a memory medium such as an HDD or a flash memory for storing various programs such as a Web browser and various files. The communication I/F 17 is an interface enabling the data communication among the nursing support server 2 and the terminal apparatus 3 connected through a network. The CPU 11 controls the communication I/F 17 to transmit/recept various data among the apparatus in accordance with a given communication protocol.

In addition, the handy terminal 10 includes a timing device such as an RTC (Real Time Clock) (not shown), and the CPU 11 acquires the current date/time (current month, current day, current year and current moment) based on the time information timed by the timing device. The current date/time acquired is used when the CPU 11 of the handy terminal 10 executes various programs.

The CPU 11 of the handy terminal 10 functions as an installation notifying unit 111 and a key layout unit 112 by developing and executing the programs stored in the ROM 12 or memory unit 16 in the RAM 13.

The installation notifying unit 111 notifies the terminal apparatus 3 to install a key sheet 51 onto the keyboard 131 of the input unit 15. Specifically, the installation notifying unit 111 sends an installation notice to the terminal apparatus 3 according to an installation confirmation operation (e.g. a long press on the key 123d ‘send’) of the user when the key sheet 51 is installed on the keyboard 131 of the input unit 15.

The key layout unit 112 lays out keys of the keyboard 131 of the input unit 15 based on the input item notified by the terminal apparatus 3, namely, the setting information indicative of the configuration position of a key carrying out an input item setting and the correspondence between the input items and the configuration position of the keys. Specifically, the key layout unit sets, based on the setting information notified by the terminal apparatus 3, the input item accepted when the keys of the keyboard 131 are operated. In addition, after being notified of a use permission by the terminal apparatus 3, the key layout unit 112 starts a key layout according to the setting information notified by the terminal apparatus 3, moreover, before being notified of the use permission, the key layout unit 112 installs the former key layout to accept an input.

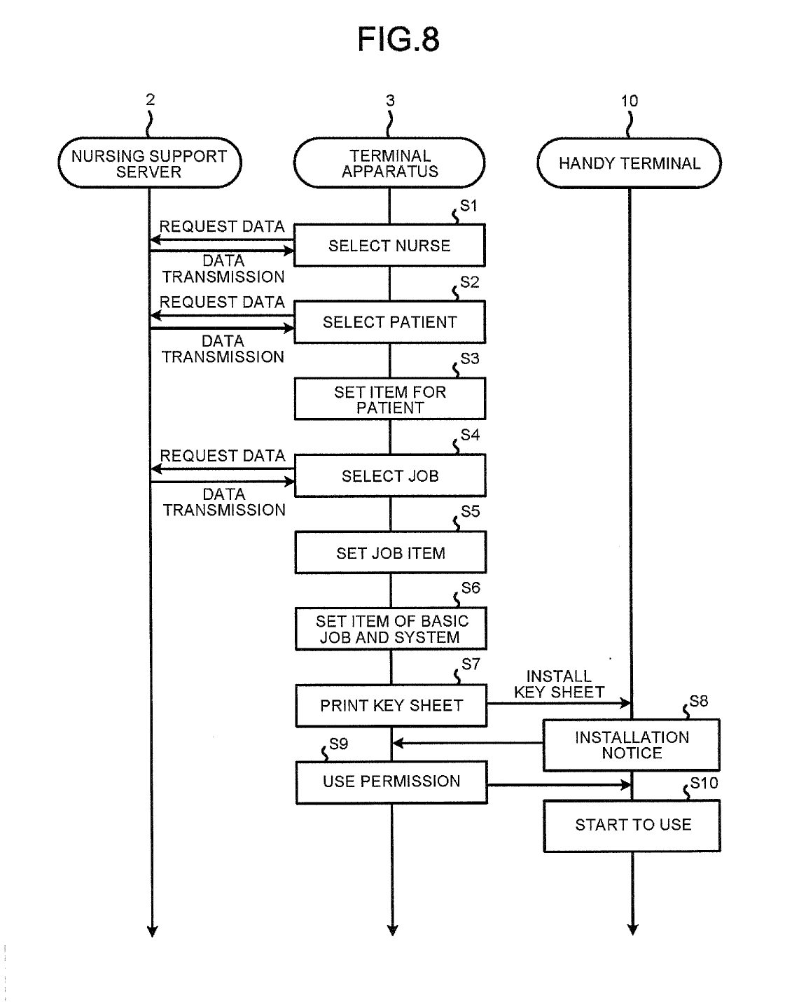

Next, the actions conducted by the nursing support system 1 to select a nurse, print the key sheet 51, install the key sheet 51 printed on the handy terminal 10 and use the key sheet 51 are exemplarily described below. FIG. 8 is a sequence diagram illustrating an example of the actions of the nursing support system 1.

As shown in FIG. 8, the data corresponding to a data request of a nurse recorded in the nurse DB 21 of the nursing support server 2 is sent from the nursing support server 2, the nurse selection unit 311 of the terminal apparatus 3 displays, on this basis, a selection screen selected from a list of nurses displayed on the display unit 34 and accepts the operation conducted by the user using the input unit 35 to select a nurse to use the handy terminal 10 (S1).

Then, the item setting unit 312 of the terminal apparatus 3 selects the patient to be taken care of by the nurse selected by the nurse selection unit 311 (S2) and sets an input items for the selected patient (S3). Specifically, the request of the patient data is carried out on the nurse DB 21 of the nursing support server 2 by using the nurse ID identifying the nurse selected by the nurse selection unit 311, and the data of the patient ID identifying the patient is sent from the nursing support server 2. Further, the department the patient visits and ward number of the ward where the patient is in are requested on the patient DB 22 of the nursing support server 2 by using the patient ID, and after the department and the ward number are accepted by the nursing support server 2, input items corresponding to the department and the ward number are to be set.

For example, if a nurse whose nurse is ID ‘1001’ is selected from the nurse DB 21 exemplarily shown in FIG. 2, a patient whose patient ID is ‘2001’ is selected as the patient to be taken card of by the nurse. For the patient whose patient ID is ‘2001’, a department ‘Internal Medicine (urinary organ)’ and a ward room ‘201’ can be acquired by referring to the patient DB 22 exemplarily shown in FIG. 3, and input items corresponding to the ward room ‘201’ are set. Then, the item setting unit 312 of the terminal apparatus 3 selects the jobs to be conducted by the nurse selected from the nurse selection 311 (S4) and sets the input items for the selected jobs (S5). Specifically, the data of the department the nurse selected by the nurse selection unit 311 is responsible to is requested on the nurse DB 21 of the nursing support server 2 by using the nurse ID identifying the nurse, and the transmission data of the department is sent from the nursing support server 2. The jobs the selected nurse is responsible to mainly relates to the department recorded in the nurse DB 21 and the department the patient visits. Therefore, job item data is requested on the nursing job DB 23 of the nursing support server 2 by using the department selected from the nurse DB 21 and the department the patient selected from the patient DB 22 is responsible to, and job item data of the job the nurse is responsible to is accepted from the nursing support server 2 to set the input items corresponding to the job item.

For example, if a nurse whose nurse is ID ‘1001’ is selected from the nurse DB 21 exemplarily shown in FIG. 2, a to-be-attended department ‘Internal Medicine’ is selected. Further, as described above, ‘Internal Medicine (urinary organ)’ is selected as the department the patient taken care of by the nurse whose nurse ID is ‘1001’ visits. For the ‘Internal Medicine’ and the ‘Internal Medicine (urinary organ)’, job items ‘collect blood’ and ‘renal function’ can be acquired by referring to the nursing job DB 23 exemplarily shown in FIG. 4, and input items corresponding to ‘collect blood’ and ‘renal function’ are to be set.

Next, the item setting unit 312 of the terminal apparatus 3 sets preset basic jobs and input items of the system (S6) to create setting information describing the input items set in S3, S5 and S6 and the correspondence between the configuration positions of keys and the input items.

Then, the printing control unit 313 generates, based on the created setting information, printing information and outputs the generated printing information to the printer 4, and prints the key sheet 51 (S7). The printed key sheet 51 is installed on the keyboard 131 on the input unit 15 of the handy terminal 10 by a nurse and the like.

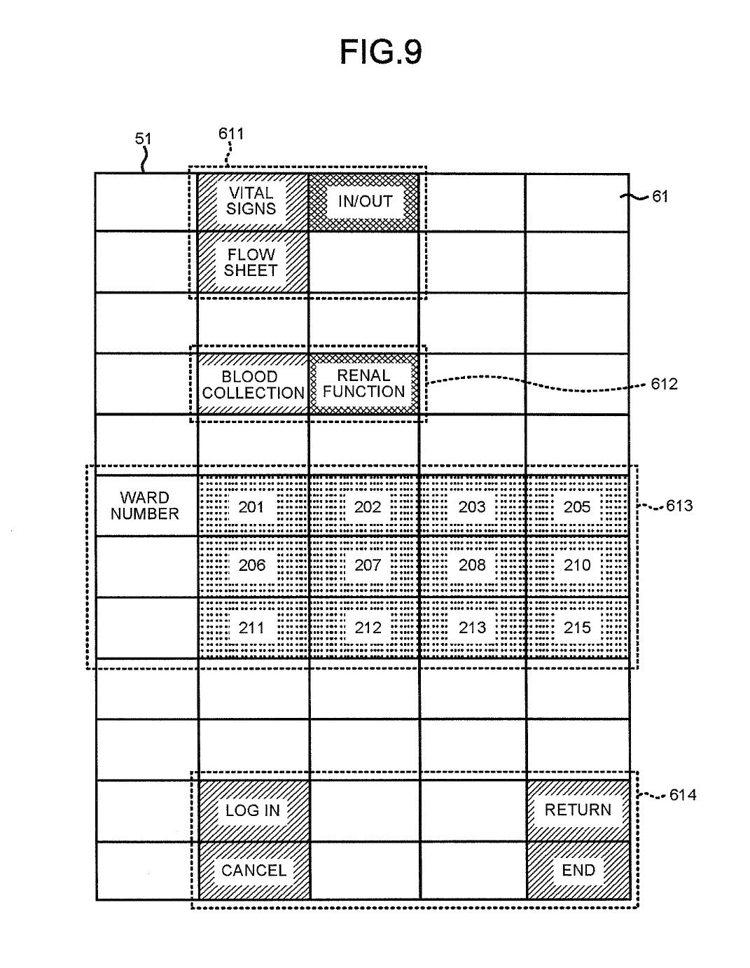

FIG. 9 is a diagram exemplarily illustrating a printed key sheet 51. As shown in FIG. 9, the basic job item 611, the job item 612, the ward room item 613 and the system item 614 set in S3, S5 and S6 are printed on the key sheet 51. Here, the job item 612 is the input item for the job of the nurse selected in S1 is responsible to. Here, the ward room item 613 is the input item for the patient to be attended by the nurse selected in S1. Thus, when the nurse selected in S1 uses the handy terminal 10, the job conducted frequently and the input items for the patient are to be set on the key sheet 51.

The installation notifying unit 111 of the handy terminal 10 sends an installation notice to the terminal apparatus 3 according to an installation confirmation given after the key sheet 51 is installed (S8). The communication control unit 314 of the terminal apparatus 3 notifies the handy terminal 10 of a use permission and setting information according to the installation notice from the handy terminal 10 (S9). The key layout unit 112 of the handy terminal 10 enables, based on the use permission from the terminal apparatus 3, an operation effectively on a key layout according to the setting information notified by the terminal apparatus 3 and starts to use the key sheet 51 printed in S7 (S10).

As described above, the nursing support system 1 comprises the handy terminal 10 and the terminal apparatus 3 capable of communicating with the handy terminal 10. The terminal apparatus 3 selects a responsible person who uses the handy terminal 10 and sets, by referring to the nurse DB 21, input items of the handy terminal 10 corresponding to the patient and the department the selected nurse is responsible to. Further, the terminal apparatus 3 prints, based on the set input items, the key sheet 51 installed on the input unit 15 of the handy terminal 10 by using the printer 4 and notifies the handy terminal 10 of the set input items. The handy terminal 10 lays out keys of the input unit 15 based on the input items notified by the terminal apparatus 3. Thus, in the nursing support system 1, by selecting a nurse to use the handy terminal 10, input items corresponding to the patient and the department the selected nurse is responsible to are set as a key layout of the handy terminal 10, thus facilitating the setting of the key layout of the handy terminal 10 aiming at each nurse.

Further, the programs executed by the terminal apparatus 3 or the handy terminal 10 described herein are compiled in an ROM and the like in advance are provided. The programs executed by the terminal apparatus 3 or the handy terminal 10 are also can be provided as an installable or executable file which recorded in the read-able record medium such as a CD-ROM, FD, CD-R, DVD (Digital Versatile Disk) and the like of computer.

Moreover, the program executed by the terminal apparatus 3 or the handy terminal 10 can be also configured to store in a computer and connected with a network such as the Internet and the like, so long as it can be provided by being downloaded through the network. In addition, the program can also be configured so long as it can be provided or distributed by a network such as the Internet and the like.

It is set the programs executed by the terminal apparatus 3 or the handy terminal 10 described herein consist of modules including the functional configurations described above and read from the ROM by a CPU as actual hardware and then executed by the CPU to load the functional components to a main memory apparatus and to generate the functional configurations on the main memory apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nursing support system, including a handy terminal and an information processing apparatus capable of communicating with the handy terminal,
the information processing apparatus comprising:
a selection unit configured to select a responsible person to use the handy terminal;
an item setting unit configured to set input items of the handy terminal corresponding to the patient and the department of the selected responsible person by referring the information of the responsible person recording the patient and the department of the responsible person for every responsible persons;
a printing unit configured to print a key sheet installed on the input unit of the handy terminal based on the set input items; and
an item notifying unit configured to notify the handy terminal of the set input items, wherein
the handy terminal includes a key layout unit configured to lay out keys of the input unit based on the input items notified by the information processing apparatus.

2. The nursing support system according to claim 1, wherein
the item setting unit sets input items corresponding to the visited department and the ward number of the selected responsible person by referring the information of the patient recording the visited department and the ward number of the patient every patients.

3. The nursing support system according to claim 1, wherein
the handy terminal includes an installation notifying unit configured to notify the information processing apparatus to install a printed key sheet on the input unit;
the item notifying unit notifies a use permission for the use of the input items notified to the handy terminal according to the installation of the printed key sheet on the input unit notified by the handy terminal; and
the key layout unit starts to accept the input of the input unit in accordance with the key layout based on the use permission notified by the information processing apparatus.

4. The nursing support system according to claim 2, wherein
the handy terminal includes an installation notifying unit configured to notify the information processing apparatus to install a printed key sheet on the input unit;
the item notifying unit notifies a use permission for the use of the input items notified to the handy terminal according to the installation of the printed key sheet on the input unit notified by the handy terminal; and
the key layout unit starts to accept the input of the input unit in accordance with the key layout based on the use permission notified by the information processing apparatus.

5. A nursing support method, comprising:
selecting a responsible person to use a handy terminal;
setting input items of the handy terminal corresponding to the patient and the department of the selected responsible person by referring the information of the responsible person recording the patient and the department of the responsible person for every responsible persons;
printing a key sheet installed on the input unit of the handy terminal based on the set input items; and
notifying the handy terminal of the set input items via a communication unit.

6. The nursing support method according to claim 5, wherein
the input items corresponding to the visited department and the ward number of the selected responsible person are set by referring the information of the patient recording the visited department and the ward number of the patient every patients.

7. The nursing support method according to claim 5, wherein
the handy terminal is notified a use permission for the use of the input items notified to the handy terminal according to the installation of the printed key sheet on an input unit notified by the handy terminal via the communication unit.

8. The nursing support method according to claim 6, wherein
the handy terminal is notified a use permission for the use of the input items notified to the handy terminal according to the installation of the printed key sheet on an input unit notified by the handy terminal via the communication unit.
